(19) United States
(12) Patent Application Publication
(10) Pub. No.: US 2024/0340794 A1
(43) Pub. Date: Oct. 10, 2024

(54) METHOD AND APPARATUS FOR SYNCHRONIZING TIMING OF LOW POWER WAKEUP SIGNAL AND ACTIVATING/DEACTIVATING LOW POWER WAKEUP SIGNAL MONITORING

(71) Applicant: MediaTek Inc., Hsin-chu (TW)

(72) Inventors: Chien-Chun Cheng, Hsinchu City (TW); Wei-De Wu, Hsinchu City (TW); Yi-Chia Lo, Hsinchu City (TW); Yi-Ju Liao, Hsinchu City (TW)

(73) Assignee: MediaTek Inc., Hsin-chu (TW)

(21) Appl. No.: 18/585,004

(22) Filed: Feb. 22, 2024

Related U.S. Application Data
(60) Provisional application No. 63/457,858, filed on Apr. 7, 2023.

(51) Int. Cl. H04W 52/02; H04W 56/00; H04W 76/20

(52) U.S. Cl. CPC H04W 52/0235; H04W 56/0015; H04W 76/20

(57) ABSTRACT

A communication apparatus includes a low power wakeup receiver (LP-WUR) and a processor. The processor is configured to receive signals from a network apparatus via the LP-WUR, and perform operations including: receiving at least one synchronization signal sent by the network apparatus, wherein the at least one synchronization signal comprises at least one of a primary synchronization signal (PSS) and a secondary synchronization signal (SSS); and using the at least one synchronization signal to detect timing of a low power wakeup signal (LP-WUS).

### CROSS REFERENCE TO RELATED APPLICATIONS

This application claims the benefit of U.S. Provisional Application No. 63/457,858, filed on Apr. 7, 2023. The content of the application is incorporated herein by reference.

### BACKGROUND

The present invention relates to wireless communications, and more particularly, to a method and apparatus of synchronizing timing of a low power wakeup signal and activating/deactivating low power wakeup signal monitoring.

Low power wakeup signals/wakeup receivers (LP-WUS/LP-WUR) are designed for a wireless communication system with the aim of reducing power consumption and increasing energy efficiency. A wakeup signal is used to trigger the main radio (MR), and the LPWUR is an independent receiver used to monitor the signal with ultra-low power consumption. Specifically, the MR is a transceiver used for user data transmission and reception, and the LP-WUR is a simple “wake-up” receiver that does not have a transmitter. Regarding the LP-WUR, it is active while the MR is turned off, and wakes up the MR when there is a packet to receive. Regarding the MR, it is turned off unless there is something to transmit. There is a need to achieve time synchronization of the LP-WUR for LP-WUS monitoring and reduce a false alarm rate in continuous LP-WUS monitoring.

### SUMMARY

One of the objectives of the claimed invention is to provide a method and apparatus of synchronizing timing of a low power wakeup signal and activating/deactivating low power wakeup signal monitoring.

According to a first aspect of the present invention, an exemplary communication apparatus is disclosed. The exemplary communication apparatus includes a low power wakeup receiver (LP-WUR) and a processor. The processor is configured to receive signals from a network apparatus via the LP-WUR, and perform operations including: receiving at least one synchronization signal sent by the network apparatus, wherein the at least one synchronization signal comprises at least one of a primary synchronization signal (PSS) and a secondary synchronization signal (SSS); and using the at least one synchronization signal to detect timing of a low power wakeup signal (LP-WUS).

According to a second aspect of the present invention, an exemplary communication method is disclosed. The exemplary communication method includes: receiving at least one synchronization signal via a low power wakeup receiver (LP-WUR), wherein the at least one synchronization signal comprises at least one of a primary synchronization signal (PSS) and a secondary synchronization signal (SSS) sent by a network apparatus; and using the at least one synchronization signal to detect timing of a low power wakeup signal (LP-WUS).

According to a third aspect of the present invention, an exemplary network apparatus is disclosed. The exemplary network apparatus includes a transmitter and a processor. The processor is configured to send signals to a communication apparatus via the transmitter, and perform operations including: sending at least one synchronization signal to the communication apparatus, wherein the at least one synchronization signal comprises at least one of a primary synchronization signal (PSS) and a secondary synchronization signal (SSS); and sending a low power wakeup signal (LP-WUS) to the communication apparatus according to a timing offset between the at least one synchronization signal and the LP-WUS.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an issue graph according to an embodiment of the present invention.

FIG. 2 is a sequence diagram illustrating interactions between UE and gNB according to an embodiment of the present invention.

FIG. 3 is a diagram illustrating an NR PSS transmitted from gNB to UE according to an embodiment of the present invention.

FIG. 4 is a sequence diagram illustrating interactions between UE and gNB according to an embodiment of the present invention.

FIG. 5 is a diagram illustrating an OOK-based receiver according to an embodiment of the present invention.

FIG. 6 is a sequence diagram illustrating interactions between UE and gNB according to an embodiment of the present invention.

FIG. 7 is a diagram illustrating an OFDMA-based LPWUR according to an embodiment of the present invention.

FIG. 8 is a diagram illustrating a main radio that generates PSS candidates with fewer hypotheses according to an embodiment of the present invention.

FIG. 9 is a sequence diagram illustrating interactions between UE and gNB according to an embodiment of the present invention.

FIG. 10 is a diagram illustrating an accumulated FAR resulting from 400 LPWUR monitoring attempts.

FIG. 11 is a diagram illustrating that LPWUR does not expect to receive another LPWUS for a certain time according to an embodiment of the present invention.

FIG. 12 is a sequence diagram illustrating interactions between UE and gNB according to an embodiment of the present invention.

FIG. 13 is a sequence diagram illustrating interactions between UE and gNB according to an embodiment of the present invention.

FIG. 14 is a diagram illustrating a communication system according to an embodiment of the present invention.

FIG. 15 is a flowchart illustrating operations performed by a communication apparatus (e.g., UE) for time synchronization of LP-WUR according to an embodiment of the present invention.

FIG. 16 is a flowchart illustrating operations performed by a network apparatus (e.g., gNB) for time synchronization of LP-WUR according to an embodiment of the present invention.

FIG. 17 is a flowchart illustrating operations performed by a communication apparatus (e.g., UE) for activation/deactivation of LP-WUS according to an embodiment of the present invention.

FIG. 18 is a flowchart illustrating operations performed by a network apparatus (e.g., gNB) for activation/deactivation of LP-WUS transmission according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

The disclosure provided describes five issues related to Low Power Wake Up Signals (LPWUS) and Low Power Wake Up Receivers (LPWUR). The first issue is how to decode PSS via LPWUR, which is a challenge due to the limited bits and small dynamic range of the simplest LPWUR. The second issue is how to reduce preamble overhead, as LPWUR uses the same On-Off Keying (OOK) symbol duration for both the preamble and data payload. The third issue is how to link PSS and LPWUS for cell identification, as PSS only provides parts of a cell ID and the LPWUR may not know which cell the signal is from. The fourth issue is how to support continuous monitoring, as LPWUR has no pre-defined search space and may lead to wrongly waking up the Main Receiver (MR) and wasting transition energy. The fifth issue is how to increase TX diversity, as OOK waveforms have no cycle prefix (CP) and no Quadrature Sinusoidal Component.

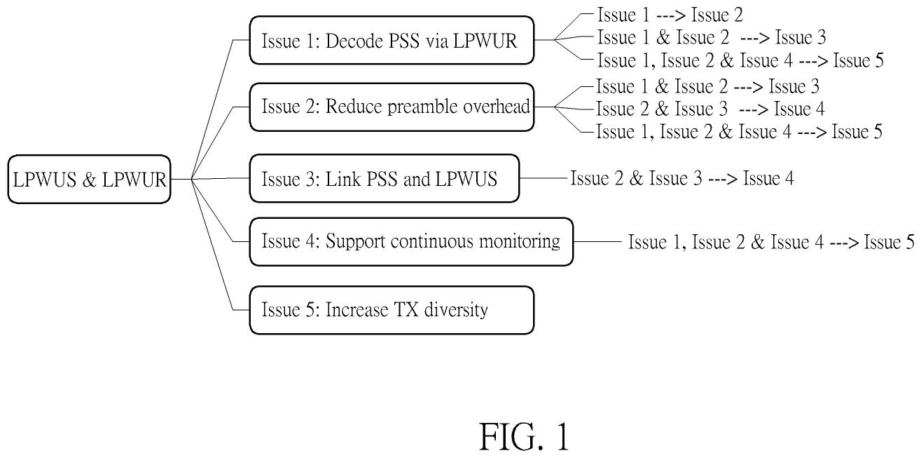

The five issues are related in the sense that they are all related to LPWUS and LPWUR, as illustrated in FIG. 1. The first issue is related to the second issue, as the preamble is used to decode the PSS. The third issue is related to the first and second issues, as PSS is used to link PSS and LPWUS for cell identification. The fourth issue is related to the second and third issues, as continuous monitoring can lead to wrongly waking up the MR and wasting transition energy. The fifth issue is related to the first, second, and fourth issues, as the TX diversity can be used to reduce preamble overhead, decode PSS, and support continuous monitoring.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIOT), and 6th Generation (6G), the proposed concepts, schemes and any variation (s)/derivative (s) thereof may be implemented in, for and by other types of radio access technologies, networks and network topologies. Thus, the scope of the present disclosure is not limited to the examples described herein.

Implementations in accordance with the present disclosure relate to various techniques, methods, schemes and/or solutions pertaining to using on-demand reference signal for network energy saving with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

### Issue 1: How to Decode PSS Via LPWUR

NR receivers have IQ branches and sufficient ADC range and resolutions to monitor NR PSS in the time domain. However, the simplest LPWUR has a single in-phase branch and limited bits and a small dynamic range. It is unclear whether LPWUR can reuse NR PSS for synchronization and Cell ID detection.

One embodiment is to apply signal processing techniques to enhance the performance of the LPWUR for NR PSS detection. For example, the LPWUR can be used in a frequency-domain approach, where the PSS is estimated from the frequency-domain samples of the LPWUR's output. This approach has the advantage of reducing the number of samples that need to be processed, thus increasing the detection speed and accuracy. Additionally, advanced signal processing techniques such as adaptive filtering and noise cancellation can be used to improve the accuracy of the PSS detection.

Another embodiment is to use the LPWUR in combination with a higher-resolution receiver such as an IQ receiver. The IQ receiver can be used to detect the NR PSS while the LPWUR can be used to detect the Cell ID. This approach has the advantage of providing the UE with both the PSS and Cell ID information.

Finally, the UE can also use a combination of the LPWUR and IQ receiver to detect both the PSS and Cell ID simultaneously. This approach has the advantage of providing the UE with both the PSS and Cell ID information in a single pass.

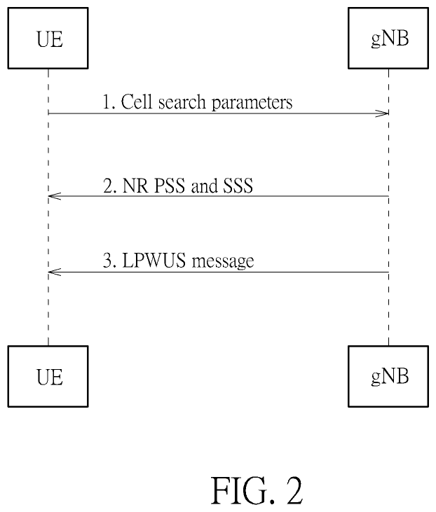

From the UE behavior perspective, the UE needs to detect the PSS and SSS transmitted by the gNB. To do this, the UE needs to be configured with the appropriate parameters for the NR PSS and SSS detection. This includes the cell search parameters, such as frequency and timing offsets, as well as the synchronization parameters, such as the PSS and SSS sequences, as illustrated in FIG. 2.

From the gNB perspective, the gNB needs to transmit the NR PSS and SSS signals to the UEs in its coverage area, as illustrated in FIG. 2. To do this, the gNB needs to be configured with the appropriate parameters for the NR PSS and SSS transmission. This includes the cell search and synchronization parameters, such as the frequency and timing offsets, as well as the PSS and SSS sequences.

From the signaling perspective, the gNB needs to send an LPWUS message to the UE containing the new PSS and SSS parameters, as illustrated in FIG. 2. This message needs to be sent on the appropriate Physical Downlink Control Channel (PDCCH) or Physical Downlink Shared Channel (PDSCH) and should include the necessary parameters for the NR PSS and SSS transmission.

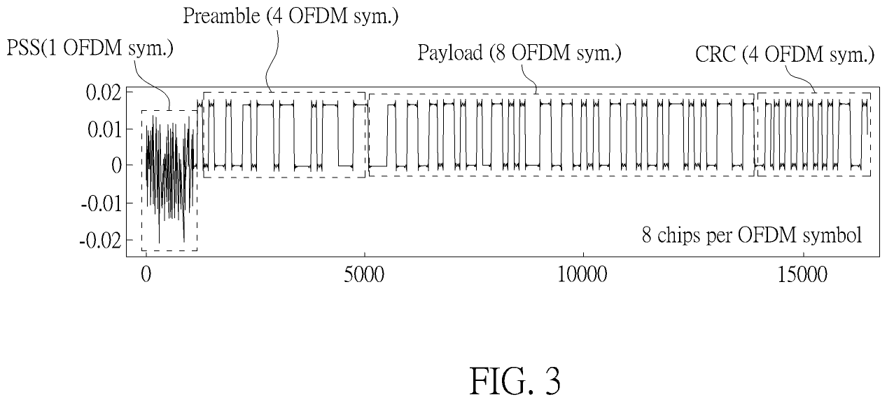

Overall, both the UE and gNB need to be properly configured and the gNB needs to send the appropriate signaling message in order for the NR PSS (shown in FIG. 3) and SSS to be transmitted and detected by the UE.

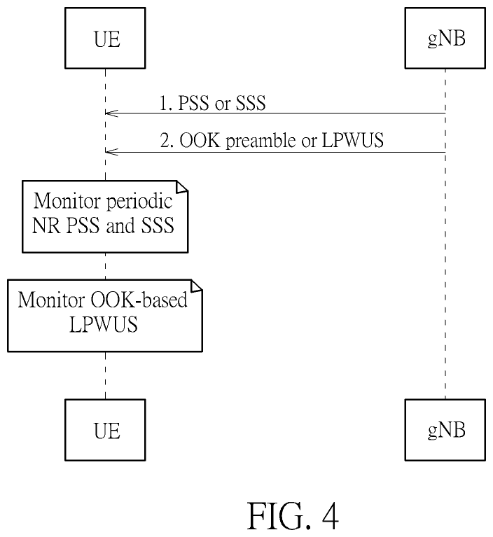

The embodiments of the present disclosure are directed to a user equipment (UE) and a base station (gNB) that provide a low power wakeup of the UE. The gNB broadcasts a primary synchronization signal (PSS) and a secondary synchronization signal (SSS) for the UE, as illustrated in FIG. 4. The gNB also broadcasts an OOK preamble or a low power wakeup signal (LPWUS) for the UE, as illustrated in FIG. 4. The UE monitors periodic NR PSS and SSS for duty cycle and serving cell relaxation. The UE also monitors the OOK-based LPWUS to reduce hardware complexity and power consumption, as illustrated in FIG. 4.

To maintain duty cycle and serving cell relaxation, the UE monitors periodic NR PSS and SSS for a predetermined duration. This allows the UE to periodically check for any changes in the serving cell or any new LPWUS broadcasted by the gNB. The UE also monitors the OOK-based LPWUS to reduce hardware complexity and power consumption. The OOK-based LPWUS is monitored in parallel with the PSS and SSS, which allows the UE to detect any changes in the serving cell without increasing power consumption. The LPWUS can also be used to detect any new LPWUS broadcasted by the gNB, which allows the UE to maintain a low power state while also staying up to date with any changes in the serving cell.

The UE uses the PSS and SSS broadcasted by the gNB to detect the timing of the OOK-based LPWUS. By monitoring the PSS and SSS, the UE is able to determine the offset between the PSS/SSS and the LPWUS and use this offset to synchronize the timing of the LPWUS. This allows the UE to accurately monitor the LPWUS with minimal power consumption. Additionally, the UE can use the PSS and SSS to detect any changes in the serving cell that may affect the LPWUS. This allows the UE to stay up to date with any changes and maintain a low power state.

The UE provides feedback to the gNB about the context by monitoring periodic NR PSS and SSS for a predetermined duration, as well as OOK-based LPWUS. This allows the UE to detect any changes in the serving cell or any new LPWUS broadcasted by the gNB without increasing power consumption. The UE can also use the LPWUS to detect any new LPWUS broadcasted by the gNB, which allows the UE to maintain a low power state while also staying up to date with any changes in the serving cell. The feedback from the UE to the gNB includes information about changes in the serving cell, such as any new LPWUS broadcasted by the gNB. This allows the UE to maintain a low power state while also staying up to date with any changes in the serving cell.

In order to make sure the UE can receive PSS and SSS and LPWUS using the same low pass filter, it is necessary for the gNB to schedule PSS and SSS and LPWUS in the same frequency band or bandwidth part. This can be achieved by setting up the frequency band or bandwidth part in such a way that all the signals can be received by the UE without any distortion or attenuation. Additionally, the filter should be designed with a high enough order to ensure that all the signals are passed with minimal distortion.

The offset between the PSS and LPWUS can be defined by the gNB when broadcasting the PSS and LPWUS. The gNB can specify the offset when configuring the PSS and LPWUS transmission parameters. Additionally, the UE can use the PSS and SSS broadcasted by the gNB to detect the timing of the OOK-based LPWUS and use this offset to synchronize the timing of the LPWUS. When defining the offset between the PSS and LPWUS, it is important to consider factors such as the size of the frequency band or bandwidth part, the power consumption of the UE, and the characteristics of the LPWUS. Additionally, the offset should be configured in such a way that the UE can accurately monitor the LPWUS without increasing power consumption.

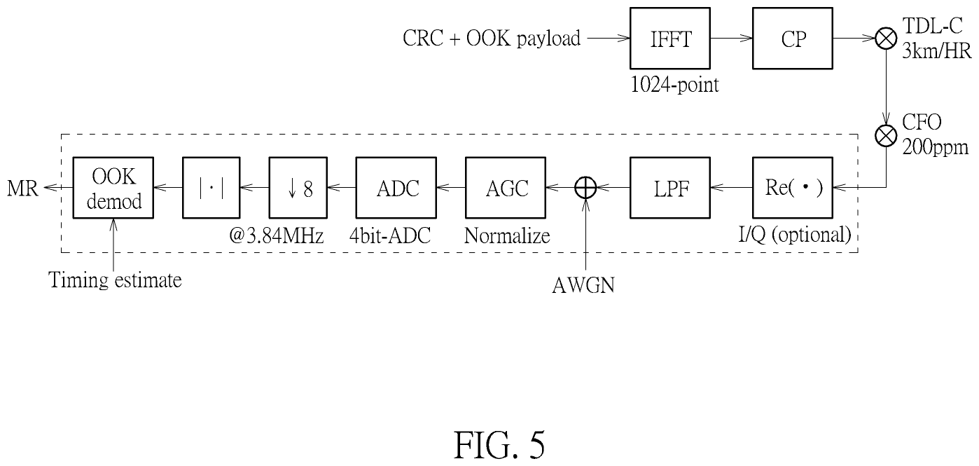

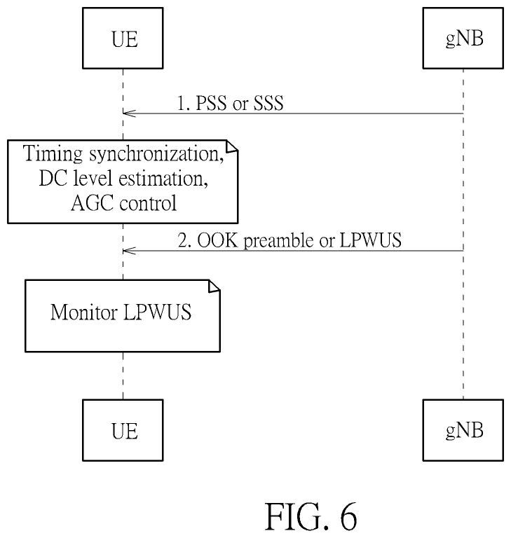

The OOK-based receiver shown in FIG. 5 has an envelope detector to decode the LPWUS, and only the low-bit resolution of ADC is needed due to the two levels of On-Off Keying. The independent receiver provides timing synchronization and estimates the DC level, as illustrated in FIG. 6. The OOK-based receiver also includes an Auto Gain Control (AGC) module to estimate the ADC range to prevent multi-path fading channel and phase noise. The AGC module estimates the DC level with the average of the received signal power from the independent receiver that monitors PSS and SSS.

When the UE receives the payload and CRC modulated by the OOK waveform, the received signal passes through a low pass filter, auto-gain control, analog to digital converter (ADC), envelop detector (ED), and OOK demodulator. The OOK demodulator uses Manchester decoding to decode the received payload and CRC. The UE then checks the CRC and payload to determine whether to wake up the MR, as illustrated in FIG. 6. The timing estimation is needed for OOK demodulation, and it is provided by an independent receiver that monitors PSS, SSS, or other existing NR signal such as CSI-RS.

The UE performs Manchester decoding to decode the payload and CRC modulated by the OOK waveform. In order to perform Manchester decoding, the UE needs to know the Manchester code rate and timing. The Manchester code rate is used to determine the number of bits used to represent a symbol and the timing is used to determine the duration of the symbol in the encoded bit stream.

The timing and the code rate of the Manchester encoded signal can be determined by the receiver. The code rate is usually determined by the transmitter and sent along with the signal so the receiver can determine the code rate. The timing can be determined by measuring the time between the beginning of a symbol and the end of the symbol. This can be done by measuring the time between the rising and falling edges of the signal.

The gNB can provide information about the timing and code rate of the Manchester encoded signal via signaling. This information can be sent to the receiver via a control channel, such as the Physical Downlink Control Channel (PDCCH), MAC-CE or RRC. The qNB can also provide information about the modulation type and other parameters related to the signal, such as the symbol rate, coding rate, and modulation order. This information can be used by the receiver to decode the signal correctly.

The UE can use a combination of the information provided by the gNB and the information determined by the receiver to know the timing and code rate of the Manchester encoded signal. The gNB can provide information about the modulation type and other parameters related to the signal, such as the symbol rate, coding rate, and modulation order. The receiver can then use this information to determine the code rate and timing of the signal. The receiver can also measure the time between the beginning of a symbol and the end of the symbol to determine the timing of the signal. By combining this information, the receiver can accurately determine the timing and code rate of the Manchester encoded signal.

If the CRC is correct, the UE can proceed to decode the payload. If the CRC is wrong, the UE will discard the received data and will not attempt to decode it. The UE may also send an acknowledgement to the transmitter to indicate that the received data was incorrect. This allows the transmitter to send the data again if necessary. LPWUR may not be able to transmit data, so it cannot be used to send acknowledgements. However, it is possible for the receiver to send acknowledgements using the MR.

If there is no timing information available, the UE can use a method called clock synchronization to determine the timing of the Manchester encoded signal. Clock synchronization is a process by which the receiver can compare the received signal to a reference clock signal and adjust its timing accordingly. This allows the receiver to accurately determine the timing of the signal and decode it correctly.

If LPWUR does not have an internal clock, the UE can use an external clock signal to provide timing information. This clock signal can be provided by the transmitter or another device in the network. The UE can then use this clock signal to synchronize its timing with the transmitter, allowing it to accurately decode the Manchester encoded signal.

If LPWUR can share a clock from the main radio, the UE can use the clock signal to synchronize its timing with the transmitter. This allows the UE to accurately decode the Manchester encoded signal. The UE can also use the clock signal to measure the time between the beginning of a symbol and the end of the symbol, which can be used to determine the timing of the signal. The UE can also use the clock signal to determine the code rate of the signal, which is used to determine the number of bits used to represent a symbol.

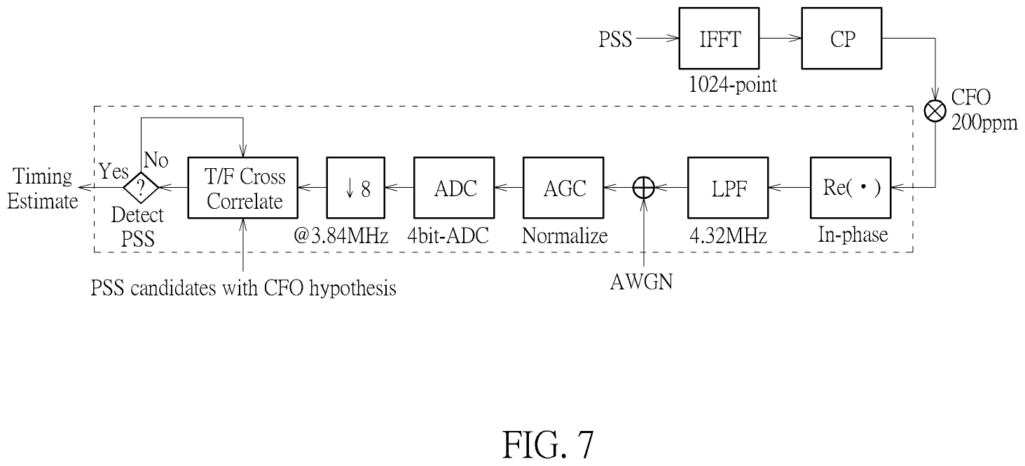

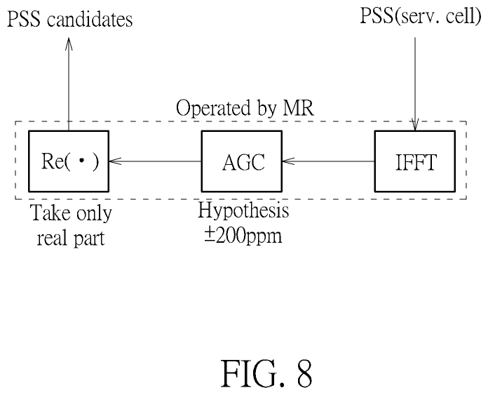

The embodiments of the present disclosure are directed to a user equipment (UE) and a base station (gNB) that provide a low power wakeup of the UE. The gNB broadcasts a primary synchronization signal (PSS) and a secondary synchronization signal (SSS) for the UE. The UE has an OFDMA-based LPWUR that provides timing information and the DC level estimation (or RSRP) via the existing OFDM-based signal. The OFDMA-based LPWUR shown in FIG. 7 considers no I/Q branches, a 200 ppm LO, and the ADC with 3.84 MHz and 4-bit resolution. To reduce the power consumption and the risk of false alarms, the main radio (MR) shown in FIG. 8 generates the PSS candidates with fewer hypotheses and stays awake before LPWUR has built up its synchronization.

UE receives NR PSS and passes it through a low pass filter. The low pass filter can be used to receive LPWUS if the PSS and LPWUS share the same resource element (RE) range. The filtered signal then has AGC and ADC processing to normalize and digitize for the baseband processing. The time and frequency correlator performs cross correlation between the received signal and the PSS candidates with CFO hypothesis. The PSS candidates can be provided by the MR to reduce the computational complexity of LPWUR. If the cross correlation result is greater than a threshold, then UE declare the PSS is detected and use it to estimate the timing and frequency.

The primary synchronization signal (PSS) Received Signal Reference Power (RSRP) is defined as the average energy of the signal per resource element (RE) over the bandwidth of the signal. The PSS RSRP can be calculated using the OFDMA-based LPWUR. The LPWUR provides timing information and the DC level estimation (or RSRP) via the existing OFDM-based signal. The DC level estimation is used to calculate the PSS RSRP by taking the average energy of the signal per RE over the bandwidth of the signal.

The DC level estimation is used to calculate the PSS RSRP from the OFDMA-based LPWUR. The DC level estimation is the average power of the signal over the bandwidth of the signal. It is calculated by taking the mean of the signal samples over the bandwidth of the signal. The DC level estimation is used to calculate the PSS RSRP by taking the average energy of the signal per RE over the bandwidth of the signal.

If the main radio (MR) knows the PSS sequence and frequency error, it can generate the PSS candidates with fewer hypotheses by only considering the frequency error and PSS sequence that it knows. This will reduce the number of PSS candidates and minimize the computational complexity of LPWUR. Additionally, the PSS candidates can be further reduced by only considering the frequency error range that is within the tolerance level. This will ensure more accurate PSS candidates and reduce the risk of false alarms.

The main radio (MR) staying awake before LPWUR has built up its synchronization can reduce the risk of false alarms. By having the MR generate the PSS candidates with fewer hypotheses, it reduces the computational complexity of LPWUR and provides more accurate PSS candidates, thus minimizing the risk of false alarms. Additionally, having the MR stay awake will ensure that the PSS candidates are generated in a timely manner, thus reducing the risk of false alarms.

If the UE is unable to detect the PSS, then the UE will be unable to estimate the timing and frequency and will not be able to establish synchronization. In this case, the UE will need to re-attempt the synchronization process by listening for the PSS again. However, the UE only needs to listen for the PSS for a given amount of time, which is provided by the gNB via RRC or SI.

The UE can support duty cycle to reduce the amount of time it spends listening for the PSS. Duty cycle is a technique that allows the UE to turn off its receiver periodically, thus reducing its power consumption. The UE can be configured to turn off its receiver for a certain amount of time and then turn it back on to listen for the PSS. This will reduce the amount of time the UE is listening for the PSS, thus reducing its power consumption.

The embodiments of the present disclosure are directed to a user equipment (UE) and a base station (gNB) that provide a low power wakeup of the UE. The gNB broadcasts a primary synchronization signal (PSS) and a secondary synchronization signal (SSS) for the UE. The gNB also provides a timing offset between the PSS/SSS and the low power wakeup signal (LPWUS) via RRC or system information (SI) to the main radio. The UE uses an LPWUR to detect the PSS and the following LPWUS based on the offset provided by the gNB.

The embodiments of the present disclosure are directed to a user equipment (UE) and a base station (gNB) that provide a low power wakeup of the UE. The gNB broadcasts a primary synchronization signal (PSS) and a secondary synchronization signal (SSS) for the UE. The gNB also provides the LPWUS monitoring occasions to the UE via RRC or system information (SI) by the main radio (MR) or via LPWUS by the LPWUR. The monitoring occasions are within the same frequency resource elements (RE) or frequency resource block (RB) with the PSS/SSS used to build up the timing synchronization.

The UE uses an LPWUR to detect the PSS and the following LPWUS based on the offset provided by the gNB. The gNB provides the LPWUS monitoring occasions to the UE via RRC or system information (SI) by the main radio (MR) or via LPWUS by the LPWUR. The monitoring occasions are within the same frequency resource elements (RE) or frequency resource block (RB) with the PSS/SSS used to build up the timing synchronization. The RE for PSS and the LPWUS are both determined by the gNB and the UE is able to detect them based on the offset provided by the gNB.

The gNB can determine if the UE is using an LPWUR to listen to the PSS by monitoring the LPWUS monitoring occasions broadcast by the gNB. If the UE is not listening to the PSS, the gNB will not receive any response from the UE. The gNB can also monitor the LPWUS for any response from the UE to determine if the UE is using an LPWUR to listen to the PSS.

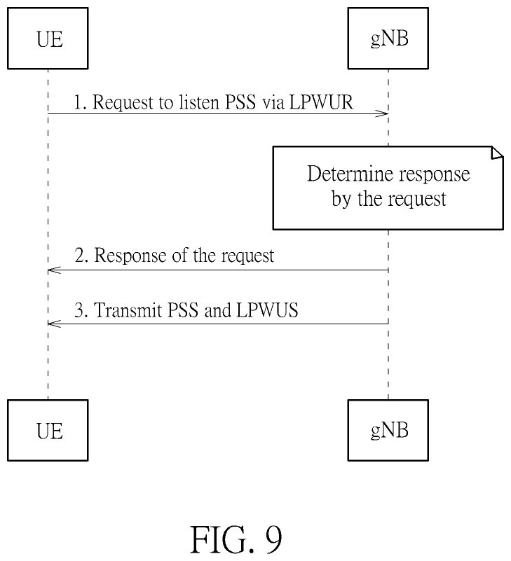

If the UE determines to use an LPWUR to listen to the PSS, it should feedback to the gNB by sending a response signal to the gNB, as illustrated in FIG. 9. The response signal can be in the form of a request for additional information, such as timing offset or frequency resource elements (RE) for the PSS and the LPWUS, or a confirmation signal indicating that the UE is ready to receive the PSS and the LPWUS.

If the UE wants to listen to the secondary synchronization signal (SSS) or another existing NR signal rather than the primary synchronization signal (PSS), the UE should request the SSS and the LPWUS monitoring occasions from the gNB. The gNB will then provide the SSS and the LPWUS monitoring occasions to the UE. The UE will then use an LPWUR to detect the SSS and the following LPWUS based on the offset provided by the gNB. The gNB will also provide the LPWUS monitoring occasions to the UE via RRC or system information (SI) by the main radio (MR) or via LPWUS by the LPWUR.

To modify the specifications in order to decode PSS via LPWUR, the following specific steps should be taken:
1. Frame Structure: The NR frame structure should be modified to support the LPWUR. This can be done by adjusting the SCS to 15 KHz and the CP length to 0.25 ms, the modulation scheme to 256QAM, and the sequence generation to Zadoff-Chu.
2. Initial Access SS/PBCH: The Initial Access SS/PBCH should be modified to support the LPWUR. This can be done by adjusting the format to 8-bit symbols and the content of the SS/PBCH to include system information, cell ID, and timing information.
3. Paging: The paging procedure should be modified to support the LPWUR. This can be done by adjusting the format to 8-bit symbols and the content of the paging messages to include information about the UE and the network.
4. PRACH: The PRACH procedure should be modified to support the LPWUR. This can be done by adjusting the format to 8-bit symbols and the content of the PRACH messages to include the access request from the UE.
5. RRM and RLM: The Radio Resource Management (RRM) and Radio Link Management (RLM) should be modified to support the LPWUR. This can be done by adjusting the parameters used for resource allocation, such as the number of available resources, the modulation scheme, and the coding rate, and link management, such as the number of retransmissions and the error correction scheme.
6. DL MIMO: The DL MIMO procedure should be modified to support the LPWUR. This can be done by adjusting the transmission schemes, such as the precoding matrix and the beamforming vector, the CSI-RS, and the related procedure, such as the scheduling and the power control.
7. UL MIMO: The UL MIMO procedure should be modified to support the LPWUR. This can be done by adjusting the transmission schemes, such as the precoding matrix and the beamforming vector, the SRS, and the related procedure, such as the scheduling and the power control.
8. Beam Management: The beam management procedure should be modified to support the LPWUR. This can be done by adjusting the parameters used for beam management, such as the beamforming vector and the beamforming weights.
9. QCL & SYNC: QCL and Synchronization (SYNC) procedure should be modified to support the LPWUR. This can be done by adjusting the timing advance (TA), the time reference signal (TRS), and the position reference signal (PTRS) to ensure that the UE and the network are synchronized.
10. PRS: The Position Reference Signal (PRS) procedure should be modified to support the LPWUR. This can be done by adjusting the format to 8-bit symbols and the content of the PRS to include the position information.
11. PDCCH: The Physical Downlink Control Channel (PDCCH) procedure should be modified to support the LPWUR. This can be done by adjusting the Demodulation Reference Signal (DMRS) to include synchronization, the Downlink Control Information (DCI) formats to include information about the PDSCH and PUSCH, and the receiving procedure to include the decoding process.
12. Channel Coding: The channel coding procedure should be modified to support the LPWUR. This can be done by adjusting the coding algorithms used for data transmission, such as the turbo coding and the LDPC coding.
13. PDSCH: The Physical Downlink Shared Channel (PDSCH) procedure should be modified to support the LPWUR. This can be done by adjusting the Demodulation Reference Signal (DMRS) to include synchronization, and the receiving procedure to include the decoding process.
14. PUCCH: The Physical Uplink Control Channel (PUCCH) procedure should be modified to support the LPWUR. This can be done by adjusting the Demodulation Reference Signal (DMRS) to include synchronization, the Uplink Control Information (UCI) multiplexing to include information about the PUSCH and the PDSCH, and the transmission procedure to include the encoding process.
15. PUSCH: The Physical Uplink Shared Channel (PUSCH) procedure should be modified to support the LPWUR. This can be done by adjusting the Demodulation Reference Signal (DMRS) to include synchronization, and the transmission procedure to include the encoding process.
16. DL HARQ: The Downlink Hybrid Automatic Repeat Request (DL HARQ) procedure should be modified to support the LPWUR. This can be done by adjusting the HARQ-ACK to include information about the transmission status.
17. PDSCH UE Processing Time: The PDSCH UE processing time should be modified to support the LPWUR. This can be done by adjusting the processing time for the PDSCH to ensure that the UE can decode the PDSCH in the allotted time.
18. PUSCH UE Processing Time: The PUSCH UE processing time should be modified to support the LPWUR. This can be done by adjusting the processing time for the PUSCH to ensure that the UE can decode the PUSCH in the allotted time.
19. BWP-specific, SUL-specific, CA-specific, and MRDC-specific: The procedures related to the BWP, SUL, CA, and MRDC should be modified to support the LPWUR. This can be done by adjusting the parameters used for these procedures, such as the number of resources, the modulation scheme, and the coding rate.
20. UL Power Control: The UL Power Control procedure should be modified to support the LPWUR. This can be done by adjusting the parameters used for power control, such as the power level and the power offset.
21. DL Channel Access: The DL Channel Access procedure should be modified to support the LPWUR. This can be done by adjusting the parameters used for channel access

### Issue 2: How to Reduce Preamble Overhead

LPWUR uses the same On-Off Keying (OOK) symbol duration for both the preamble and data payload. This makes it easier to receive the signal, but increases the overhead as the preamble is only used for timing synchronization and not for decoding information bits.

LPWUR uses the same On-Off Keying (OOK) symbol duration for both the preamble and data payload. The preamble is used for timing synchronization and not for decoding information bits, which increases the overhead. The LPWUR has to transmit more data, leading to a slower data rate.

One embodiment to reduce the preamble overhead is to use a different Symbol Coding Scheme (SCS) than the one used for the payload. For example, if the payload is encoded using On-Off Keying (OOK), the preamble can be encoded using OFDM, or Frequency-Shift Keying (FSK) or Quadrature Amplitude Modulation (QAM). These modulation techniques can decode more information bits in the same preamble duration than OOK. This will reduce the overhead and improve the data rate of the LPWUS.

Another embodiment to reduce the preamble overhead is to use a different symbol duration for the preamble than the one used for the payload. This can be done by using a shorter symbol duration for the preamble than the payload, as the preamble is only used for timing synchronization and not for decoding information bits. This will reduce the overhead and improve the data rate of the LPWUS.

The symbol duration of the preamble and payload is provided by gNB. The gNB will transmit the preamble to the UE to indicate the beginning of a transmission. The UE will then measure the symbol duration of the preamble and use that to synchronize with the BS. The BS can also provide the symbol duration of the payload by using difference preambles or preconfigured via RRC, which is usually different from the preamble symbol duration. This way, the UE will know that the symbol duration of the preamble and payload are different.

The symbol duration and coding scheme (CS) used in an LPWUS are linked, as the symbol duration is dependent on the modulation technique used. For example, if the data payload is used, the symbol duration will be longer than if the preamble is used. By using a different CS than the one used for the payload, the preamble overhead can be reduced. This will reduce the overhead and improve the data rate of the LPWUS. The coding scheme can be determined by UE or provided by gNB via LPWUS or RRC/SI.

The symbol duration and subcarrier spacing (SCS) used in an LPWUS are linked, as the symbol duration is dependent on the modulation technique used. The subcarrier spacing will be dependent on the symbol duration, as it determines the minimum frequency spacing between two adjacent subcarriers. By using a different modulation technique than the one used for the payload, the preamble overhead can be reduced. This will reduce the overhead and improve the data rate of the LPWUS. The SCS can be determined by UE or provided by gNB via LPWUS or RRC/SI.

Frame Structure: The frame structure should be designed to support the transmission of data efficiently. This can be done by using different sizes of frames depending on the type of data being transmitted. Additionally, the frame structure should be designed to minimize interference and maximize throughput.

SCS & CP: The SCS & CP should be optimized for the desired data rate and bandwidth. This can be done by selecting the appropriate symbol length and guard interval.

Modulation: The modulation technique should be selected based on the desired data rate and bandwidth. This can be done by selecting the appropriate modulation technique, such as QPSK, 16QAM, or 64QAM, depending on the desired data rate and bandwidth.

Sequence Generation: The sequence generation should be designed to provide the desired data rate and bandwidth. This can be done by selecting the appropriate parameters, such as length and type of sequences, to achieve the desired data rate and bandwidth.

Initial Access SS/PBCH: The initial access SS/PBCH should be designed to provide the desired data rate and bandwidth. This can be done by selecting the appropriate parameters, such as length and type of sequences, to achieve the desired data rate and bandwidth.

Paging: The paging should be designed to provide the desired data rate and bandwidth. This can be done by selecting the appropriate parameters, such as length and type of sequences, to achieve the desired data rate and bandwidth.

PRACH (including RACH procedure): The PRACH (including RACH procedure) should be designed to provide the desired data rate and bandwidth. This can be done by selecting the appropriate parameters, such as length and type of sequences, to achieve the desired data rate and bandwidth.

RRM, RLM, DL MIMO (including Tx schemes, CSI-RS & related procedure), UL MIMO (including Tx schemes, SRS & related procedure), beam management, QCL & SYNC (including TA, TRS, PTRS), PRS (including procedure), PDCCH (including DMRS, DCI formats, Rx procedure), channel coding, PDSCH (including DMRS, Rx procedure), PUCCH (including DMRS, UCI multiplexing, Tx procedure), PUSCH (including DMRS

Symbol Duration: Another embodiment to reduce the preamble overhead is to use a different symbol duration for the preamble than the one used for the payload. This can be done by using a shorter symbol duration for the preamble than the payload, as the preamble is only used for timing synchronization and not for decoding information bits. This will reduce the overhead and improve the data rate of the LPWUS.

Subcarrier Spacing: The symbol duration and subcarrier spacing (SCS) used in an LPWUS are linked, as the symbol duration is dependent on the modulation technique used. The subcarrier spacing will be dependent on the symbol duration, as it determines the minimum frequency spacing between two adjacent subcarriers. By using a different modulation technique than the one used for the payload, the preamble overhead can be reduced. This will reduce the overhead and improve the data rate of the LPWUS. The SCS can be determined by UE or provided by gNB via LPWUS or RRC/SI.

Coding Scheme: The symbol duration and coding scheme (CS) used in an LPWUS are linked, as the symbol duration is dependent on the modulation technique used. For example, if the data payload is used, the symbol duration will be longer than if the preamble is used. By using a different CS than the one used for the payload, the preamble overhead can be reduced. This will reduce the overhead and improve the data rate of the LPWUS. The coding scheme can be determined by UE or provided by gNB via LPWUS or RRC/SI.

gNB Configuration: The symbol duration and coding scheme of the preamble and payload is provided by gNB. The gNB will transmit the preamble to the UE to indicate the beginning of a transmission. The UE will then measure the symbol duration of the preamble and use that to synchronize with the BS. The BS can also provide the symbol duration of the payload by using difference preambles or preconfigured via RRC, which is usually different from the preamble symbol duration. This way, the UE will know that the symbol duration of the preamble and payload are different

### Issue 3: How to Link PSS and LPWUS

PSS only provides parts of a cell ID. NR receiver must combine the other part of a cell ID by SSS demodulation to detect a cell. If LPWUR reuses PSS for time and frequency synchronization, LPWUR may not know whether the received PSS is from the serving cell or an interfering one due to lack of SSS demodulation. It is unclear whether and how to build a link between PSS and LPWUS for cell identification and potential combining from multiple PSS receptions.

To build a link between PSS and LPWUS for cell identification and potential combining from multiple PSS receptions, the NR receiver must combine the other part of a cell ID by SSS demodulation to detect a cell. The SSS demodulation is required to detect the serving cell accurately, as PSS alone does not provide enough information for cell identification. Once the SSS demodulation is successful, the received PSS can be used to time and frequency synchronize the LPWUS, which can then be used to identify the serving cell and combine multiple PSS receptions.

The NR receiver must combine the other part of a cell ID by SSS demodulation to detect a cell. Once the SSS demodulation is successful, the received PSS can be used to time and frequency synchronize the LPWUS, which can then be used to identify the serving cell and combine multiple PSS receptions.

If the UE is unable to detect SSS, it cannot accurately identify the serving cell and cannot use PSS for time and frequency synchronization. In this case, alternative methods such as using a higher order signal or using a priori knowledge of the cell geometry should be used to identify the serving cell and synchronize the LPWUS.

If the UE is unable to detect SSS, it can use a priori knowledge of the cell geometry or a higher order signal to identify the serving cell and synchronize the LPWUS. Once the LPWUS is synchronized, it can be used to detect and combine multiple PSS receptions from the serving cell, thus helping to identify the serving cell even if SSS detection fails.

If the LPWUS can carry partial cell ID, the NR receiver can combine the other part of the cell ID by PSS/SSS demodulation to detect the cell. Once the PSS/SSS demodulation is successful, the received PSS can be used to time and frequency synchronize the LPWUS, which can then be used to identify the serving cell and combine multiple PSS receptions. This way, the PSS and LPWUS can be used together to detect the cell ID.

The LPWUS can carry some information that can be used with PSS to identify the serving cell. The LPWUS can be used to detect and combine multiple PSS receptions from the serving cell, thus helping to identify the serving cell even if SSS detection fails. The LPWUS also provides information about the cell geometry, which can be used to identify the serving cell. Additionally, the LPWUS can be used to detect higher order signals, which can provide the same information as SSS and can be used to identify the serving cell.

### Issue 4: How to Support Continuous Monitoring

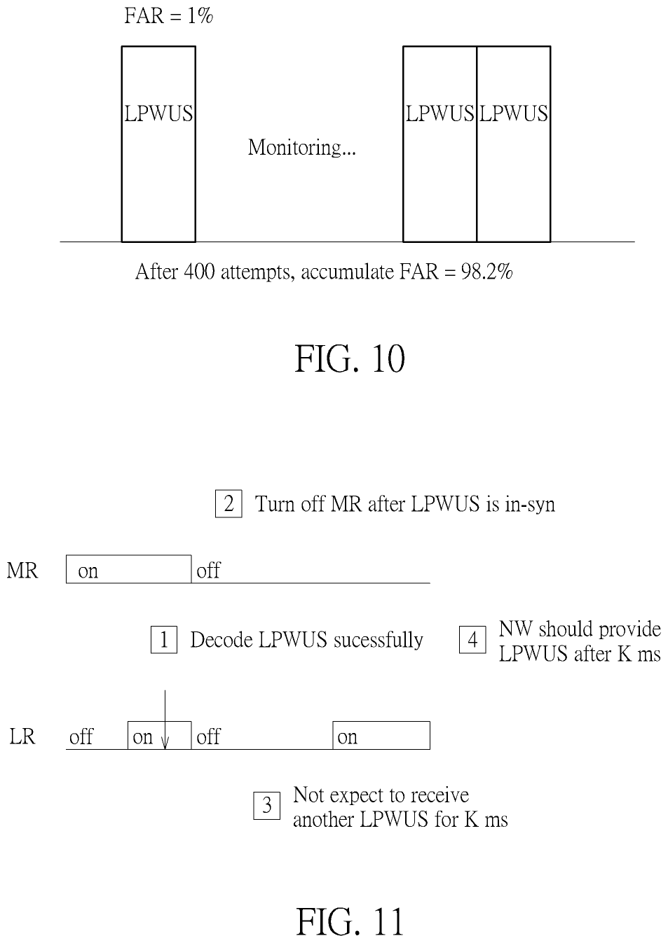

LPWUR has no pre-defined search space. If LPWUR detects LPWUS every single received sample with a sampling rate at 3.84 MHZ, LPWUR will make an LPWUS detection attempt every 0.26 us. After LPWUR continues monitoring 400 attempts, the accumulated FAR will be 98.2%, as illustrated in FIG. 10. LPWUR will most likely wake up MR due to this non-stopping monitoring, for example, every 104.2 s given 3.84 MHz. Waking MR up due to a false alarm will waste transition time and energy for turning hardware components on and off.

To reduce the chance of false alarms, LPWUR can use a pre-defined search space to limit the number of attempts for LPWUS detection. In addition, LPWUR can also use a higher sampling rate, which can reduce the time between detection attempts and thus reduce the number of false alarms. Additionally, LPWUR can use other methods such as using a priori knowledge of the cell geometry or using a higher order signal to identify the serving cell and synchronize the LPWUS before attempting LPWUS detection

UE should not turn off the MR before LPWUR receives the first LPWUS or synchronizes with the network successfully. The gNB can use signaling to detect whether the UE has turned off the MR or not. If the gNB does not receive any signalling from the UE, it can assume that the UE has turned off the MR. The UE can report to the gNB before turning off the MR by using signaling. This will allow the gNB to determine whether the UE has turned off the MR or not. The UE can report to the gNB before turning off the MR by using signalling messages such as the RRC Connection Release or the RRC Connection Reconfiguration message. It is possible to use HARQ-ACK or HARQ-NACK to report.

LPWUR should not expect to receive another LPWUS after a certain time, as illustrated in FIG. 11. To reduce the chance of false alarms, LPWUR should use a pre-defined search space to limit the number of attempts for LPWUS detection. A prohibit timer is a timer that prohibits gNB from sending LPWUS continuously. The timer is maintained by UE and gNB. If the timer runs UE is not expected another LPWUS sent by the gNB. If the timer expires or stops running, UE starts to monitor LPWUS until detected.

The impact on UE behavior will depend on the parameters and procedures defined to support LPWUR. For example, the UE may need to monitor the LPWUS for a certain period of time before turning off the MR. Additionally, the UE may need to report to the gNB before turning off the MR by using signalling messages such as the RRC Connection Release or the RRC Connection Reconfiguration message. It is also possible that the UE may need to use a pre-defined search space to limit the number of attempts for LPWUS detection in order to reduce the chance of false alarms.

The impact on gNB behavior will depend on the parameters and procedures defined to support LPWUR. For example, the gNB may need to use signaling to detect whether the UE has turned off the MR or not. Additionally, the gNB may need to use a prohibit timer to limit the number of LPWUS sent continuously. The gNB may also need to monitor the LPWUS for a certain period of time before sending another LPWUS.

The impact on signaling will depend on the parameters and procedures defined to support LPWUR. For example, the UE may need to use signaling messages such as the RRC Connection Release or the RRC Connection Reconfiguration message to report to the gNB before turning off the MR. The gNB may also need to use signaling to detect whether the UE has turned off the MR or not. Additionally, HARQ-ACK or HARQ-NACK may be used to report.

In order for UE to request gNB to send LPWUS, it needs to use the RRC Connection Setup message. This message includes the UE capability information and the requested LPWUS. The gNB then sends the LPWUS to the UE after verifying the UE capability. When the gNB receives the RRC Connection Setup message from the UE, it verifies the UE capability information and then sends the LPWUS to the UE. UE can use the pre-defined search space to monitor the LPWUS. This search space provided by gNB via RRC/SI is limited by the parameters and procedures defined to support LPWUR and is used to reduce the chance of false alarms.

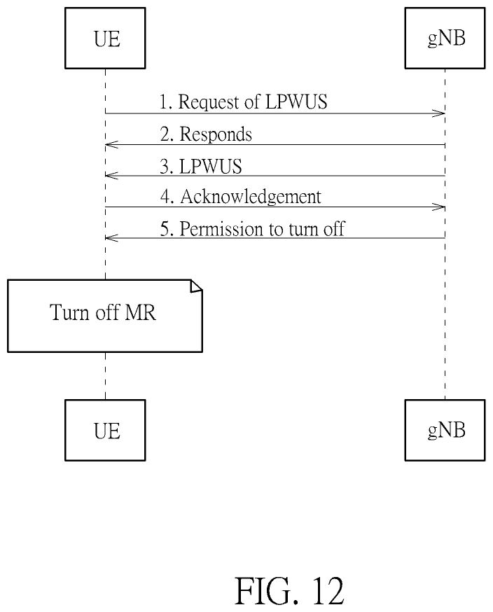

If UE can detect the LPWUS, the UE should also report to the gNB before turning off the MR, as illustrated in FIG. 12, by using signaling messages such as the RRC Connection Release or the RRC Connection Reconfiguration message. It is also possible that the UE may need to use HARQ-ACK or HARQ-NACK to report.

If UE cannot detect the LPWUS, it should use the pre-defined search space to limit the number of attempts for LPWUS detection in order to reduce the chance of false alarms. The UE should also use a higher sampling rate, which can reduce the time between detection attempts and thus reduce the number of false alarms.

There may be the indication for gNB to turn off the main radio (MR) when UE supports a LPWUR. The gNB should send a reconfiguration message to the UE to indicate that the MR should be turned off. The reconfiguration message should include the following information: the presence of a LPWUR, and the frequency used by the LPWUR. The reconfiguration message should also include information about the power level to be used for the LPWUR. Once the UE receives the reconfiguration message, it will then turn off the MR.

When the UE receives the reconfiguration message from the gNB, it will include information about the presence of a LPWUR, the frequency used by the LPWUR, and the power level to be used for the LPWUR. The UE will then turn off the MR.

The gNB will also include an uplink resource in the reconfiguration message, which will be used by the UE to send a HARQ-ACK to the gNB if the LPWUR has successfully detected the LPWUS. The PDCCH will also be used to indicate the time and frequency resource to receive LPWUS by the LPWUR. The PDCCH will also include an uplink resource for the MR to feedback HARQ-ACK if the LPWUR has successfully detected the LPWUS.

### Issue 5: How to Increase TX Diversity

OOK waveform has no cycle prefix (CP) to overcome the impact of wireless channel multi-paths. If no channel coding rather than Manchester, the decoding performance degrades when the channel has a deep fading or there are multiple strong paths in the channel. Also, OOK waveform uses In-Phase Sinusoidal Component and no Quadrature Sinusoidal Component. No Quadrature part, LPWUR has bad decoding performance when the In-Phase part of the channel has bad quality.

One embodiment is to use channel coding such as Manchester to encode the OOK waveform, which can enhance the decoding performance. Another solution is to use Quadrature Sinusoidal Component (QSC) in addition to the In-Phase Sinusoidal Component (ISC) to improve the decoding performance when the In-Phase part of the channel has poor quality. The signaling impact is that additional signalling is needed to inform the UE of the additional channel coding or QSC.

Typically, gNB only transmits LPWUS using In-Phase Sinusoidal Component (ISC). To improve the decoding performance of the LPWUS, Quadrature Sinusoidal Component (QSC) can be used in addition to the ISC. Using QSC will improve the decoding performance when the In-Phase part of the channel has poor quality, as the QSC can provide additional information about the channel that is not available with the ISC. In order to use QSC, the gNB should include the QSC information in the RRC message sent to the UE. The UE should then be able to decode the LPWUS using both the ISC and the QSC.

The reference sequence for LPWUS to use both Quadrature Sinusoidal Component (QSC) and In-Phase Sinusoidal Component (ISC) is defined in the 3GPP specification. The reference sequence is used to determine the phase of the QSC relative to the ISC, which is necessary for the UE to decode the LPWUS. The reference sequence is typically a pseudo-random binary sequence (PRBS).

In order to use QSC, the gNB should include the reference sequence in the radio bearer reconfiguration message sent to the UE. The UE should then be able to decode the LPWUS using both the ISC and the QSC. In order to generate Low Power Widely Used Signals (LPWUS) using Quadrature Sinusoidal Component (QSC) and In-Phase Sinusoidal Component (ISC), the following steps should be taken:
1. Generate the reference sequence: The reference sequence should be a pseudo-random binary sequence (PRBS).
2. Calculate the phase of the QSC: The phase of the QSC should be calculated relative to the ISC using the reference sequence.
3. Generate the ISC and QSC: The ISC and QSC should be generated using the reference sequence and the calculated phase.
4. Modulate the ISC and QSC: The ISC and QSC should be modulated using the appropriate modulation scheme.
5. Transmit the LPWUS: The LPWUS should be transmitted using the appropriate air interface.

The UE will know whether LPWUS are using In-Phase Sinusoidal Component (ISC) or both ISC and Quadrature Sinusoidal Component (QSC) based on the information in the RRC message sent by the gNB. The message should include the reference sequence, which is used to determine the phase of the QSC relative to the ISC, as well as the modulation scheme used for the LPWUS. If the reference sequence is included in the message, then the UE knows that it should use both the ISC and the QSC to decode the LPWUS. If the reference sequence is not included, then the UE knows that it should only use the ISC to decode the LPWUS.

The UE will report whether it can support In-Phase Sinusoidal Component (ISC) or both ISC and Quadrature Sinusoidal Component (QSC) in the RRC message sent to the gNB. The RRC message should include the reference sequence, which is used to determine the phase of the QSC relative to the ISC, as well as the modulation scheme used for the LPWUS. If the reference sequence is included in the message, then the gNB knows that the UE can use both the ISC and the QSC to decode the LPWUS. If the reference sequence is not included, then the gNB knows that the UE can only use the ISC to decode the LPWUS.

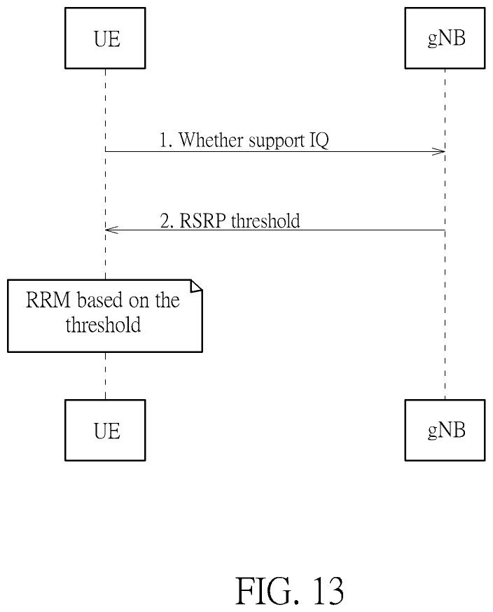

As shown in FIG. 13, the UE may receive different RSRP thresholds, OOK coding schemes, OOK data rates, repetition number, reference sequence for synchronization or RRM measurement, depending on whether UE supports QSC and ISC or not. The UE may receive both configurations and determine one of them based on whether to enable QSC and ISC for power saving purposes.

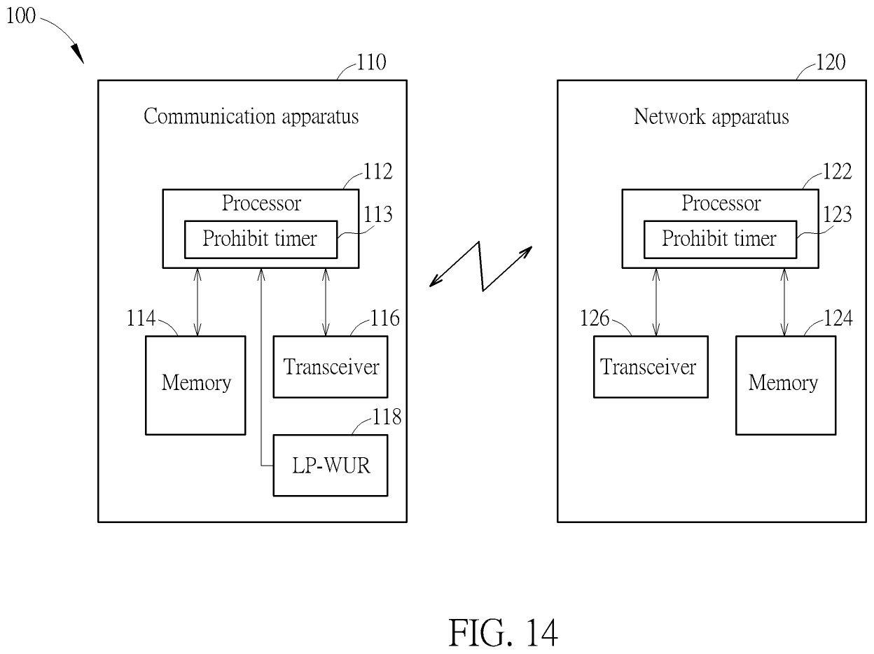

FIG. 14 is a diagram illustrating a communication system according to an embodiment of the present invention. The communication system 100 includes a communication apparatus 110 and a network apparatus 120. Each of communication apparatus 110 and network apparatus 120 may perform various functions to implement schemes, techniques, processes and methods described herein. The communication apparatus 110 may be a part of an electronic apparatus, which may be a user equipment (UE) such as a portable or mobile apparatus, a wearable apparatus, a wireless communication apparatus or a computing apparatus. For instance, the communication apparatus 110 may be implemented in a smartphone, a smartwatch, a personal digital assistant, a digital camera, or a computing equipment such as a tablet computer, a laptop computer or a notebook computer. The communication apparatus 110 may also be a part of a machine type apparatus, which may be an Internet of Things (IoT), Narrowband Internet of Things (NB-IoT), or Industrial Internet of Things (IIoT) apparatus such as an immobile or a stationary apparatus, a home apparatus, a wire communication apparatus or a computing apparatus. For instance, the communication apparatus 110 may be implemented in a smart thermostat, a smart fridge, a smart door lock, a wireless speaker or a home control center. Alternatively, the communication apparatus 110 may be implemented in the form of one or more integrated-circuits (ICs) such as, for example and without limitation, one or more single-core processors, one or more multi-core processors, one or more reduced-instruction set computing (RISC) processors, or one or more complex-instruction-set-computing (CISC) processors. The communication apparatus 110 may include at least some of those components shown in FIG. 14 such as a processor 112, for example. The communication apparatus 1710 may further include one or more other components not pertinent to the proposed scheme of the present disclosure (e.g., internal power supply, display device and/or user interface device), and, thus, such component (s) of communication apparatus 110 are neither shown in FIG. 14 nor described below in the interest of simplicity and brevity.

The network apparatus 120 may be a part of a network device, which may be a network node such as a satellite, a base station, a small cell, a router or a gateway. For instance, the network apparatus 120 may be implemented in an Evolved Node B (eNodeB) in an LTE network, in a Next Generation Node B (gNB) in a 5G New Radio (NR), IoT, NB-IoT or IIoT network or in a satellite or base station in a 6G network. Alternatively, the network apparatus 120 may be implemented in the form of one or more chips such as, for example and without limitation, one or more single-core processors, one or more multi-core processors, or one or more RISC or CISC processors. The network apparatus 120 may include at least some of those components shown in FIG. 14 such as a processor 122, for example. The network apparatus 120 may further include one or more other components not pertinent to the proposed scheme of the present disclosure (e.g., internal power supply, display device and/or user interface device), and, thus, such component (s) of the network apparatus 120 are neither shown in FIG. 14 nor described below in the interest of simplicity and brevity.

In one aspect, each of processor 112 and processor 122 may be implemented in the form of one or more single-core processors, one or more multi-core processors, or one or more CISC processors. That is, even though a singular term “a processor” is used herein to refer to processor 112 and processor 122, each of processor 112 and processor 122 may include multiple processors in some implementations and a single processor in other implementations in accordance with the present disclosure. In another aspect, each of processor 112 and processor 122 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 112 and processor 122 is a special-purpose machine specifically designed, arranged and configured to perform specific tasks.

In some implementations, the communication apparatus 110 may also include an MR (e.g., transceiver 116) coupled to the processor 112 and capable of wirelessly transmitting and receiving user data, and a low power wakeup receiver (LP-WUR) 118 coupled to the processor 112 and capable of receiving existing synchronization signals (e.g., a primary synchronization signal (PSS) and a secondary synchronization signal (SSS) that are distinct from a new low power synchronization signal (LP-SS)) and a low power wakeup signal (LP-WUS). The transceiver 116 includes a transmitter used to support the transmit (TX) function and a receiver used to support the receive (RX) function. In some implementations, the communication apparatus 110 may further include a memory 114 coupled to processor 112 and capable of being accessed by processor 112 and storing data therein.

In some implementations, the network apparatus 120 may also include a transceiver 126 coupled to processor 122 and capable of wirelessly transmitting and receiving user data, and transmitting existing synchronization signals (e.g., PSS and SSS) and the LP-WUS. The transceiver 126 includes a transmitter used to support the TX function and a receiver used to support the RX function. In some implementations, the network apparatus 120 may further include a memory 124 coupled to processor 122 and capable of being accessed by processor 122 and storing data therein.

Accordingly, the communication apparatus 110 and the network apparatus 120 may wirelessly communicate with each other via transceiver 116 and transceiver 126, respectively, and may wirelessly communicate with each other via LP-WUR (which includes no transmitter) 118 and transceiver 126 (particularly, transmitter of the transceiver 126). To aid better understanding, the following description of the operations, functionalities and capabilities of each of communication apparatus 110 and network apparatus 120 is provided in the context of a mobile communication environment in which communication apparatus 110 is implemented in or as a communication apparatus or a UE, and network apparatus 120 is implemented in or as a network node or a base station (e.g., gNB) of a communication network.

In some embodiments of the present invention, for LP-WUR that can receive existing PSS/SSS potentially assisted by physical broadcast channel (PBCH) demodulation reference signal (DMRS)/time reference signal (TRS) for synchronization, existing PSS/SSS potentially assisted by PBCH DMRS/TRS may be used for the following functionality, including radio resource management (RRM) measurements by LP-WUR, if supported; at least coarse time synchronization of LP-WUR; and at least coarse frequency synchronization of LP-WUR.

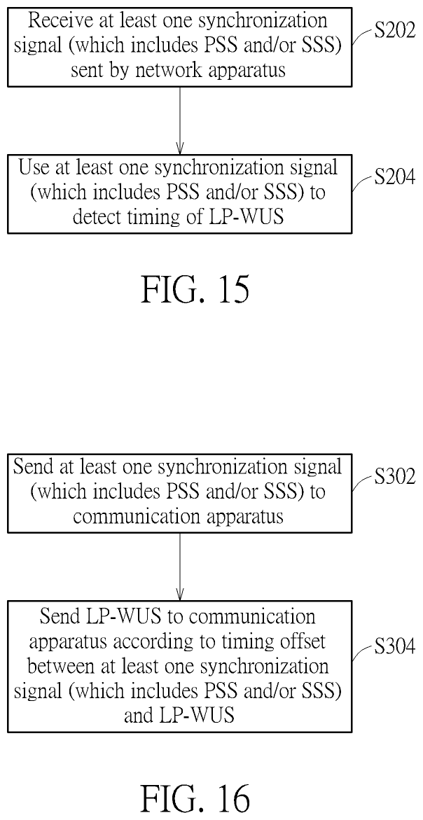

Please refer to FIG. 15 in conjunction with FIG. 14. FIG. 15 is a flowchart illustrating operations performed by the communication apparatus (e.g., UE) 110 for time synchronization of LP-WUR according to an embodiment of the present invention. The processor 112 is configured to receive signals from the network apparatus (e.g., gNB) 120 via the LP-WUR 118. At step S202, the processor 112 receives at least one synchronization signal sent by the network apparatus 120, wherein the at least one synchronization signal includes at least one of PSS and SSS. For example, the LP-WUR 118 is capable of receiving existing 5G NR synchronization signal (s) PSS/SSS sent from the network apparatus 120, and the at least one synchronization signal (which includes PSS and/or SSS) is compliant with the 5G NR standard. At step S204, the processor 112 uses the at least one synchronization signal (which includes PSS and/or SSS) to detect timing of the LP-WUS. For example, the processor 112 performs cell identification according to the at least one synchronization signal (which includes PSS and/or SSS), and when the cell identification indicates that the at least one synchronization signal (which includes PSS and/or SSS) is provided from a serving cell of the communication apparatus 110, the processor 112 uses a timing offset between the at least one synchronization signal (which includes PSS and/or SSS) and the LP-WUS to synchronize the timing of the LP-WUS. Hence, the existing synchronization signal (s) PSS/SSS can be reused for time synchronization of LP-WUR. In one embodiment, the processor 112 receives a parameter indicative of the timing offset from the network apparatus 120. For example, the parameter indicative of the timing offset may be received via the MR (i.e., transceiver 116) of the communication apparatus 110 during a configuration procedure between the communication apparatus 110 and the network apparatus 120.

In summary, UE uses the PSS and SSS broadcasted by the gNB to detect the timing of the OOK-based LPWUS. By monitoring the PSS and SSS, the UE is able to determine the offset between the PSS/SSS and the LPWUS and use this offset to synchronize the timing of the LPWUS. This allows the UE to accurately monitor the LPWUS with minimal power consumption. Additionally, the UE can use the PSS and SSS to detect any changes in the serving cell that may affect the LPWUS. This allows the UE to stay up to date with any changes and maintain a low power state.

Please refer to FIG. 16 in conjunction with FIG. 14. FIG. 16 is a flowchart illustrating operations performed by the network apparatus (e.g., gNB) 120 for time synchronization of LP-WUR according to an embodiment of the present invention. The processor 122 is configured to send signals to the communication apparatus (e.g., UE) 110 via the transceiver 126 (particularly, transmitter of transceiver 126). At step S302, the processor 122 sends at least one synchronization signal to the communication apparatus 110, wherein the at least one synchronization signal includes at least one of PSS and SSS. For example, the transceiver 126 is capable of sending existing 5G NR synchronization signal (s) PSS/SSS to the communication apparatus 110, and the at least one synchronization signal (which includes PSS and/or SSS) is compliant with the 5G NR standard. At step S304, the processor 122 sends an LP-WUS to the communication apparatus 110 according to a timing offset between the at least one synchronization signal (which includes PSS and/or SSS) and the LP-WUS. In one example, during a configuration procedure between the communication apparatus 110 and the network apparatus 120, the processor 122 configures the timing offset, and sends a parameter indicative of the timing offset to the communication apparatus 110.

In some embodiments of the present invention, UE activation and/or deactivation of LP-WUS monitoring is based on preconfigured criteria, or activation and/or deactivation of LP-WUS monitoring in a cell is based on signaling.

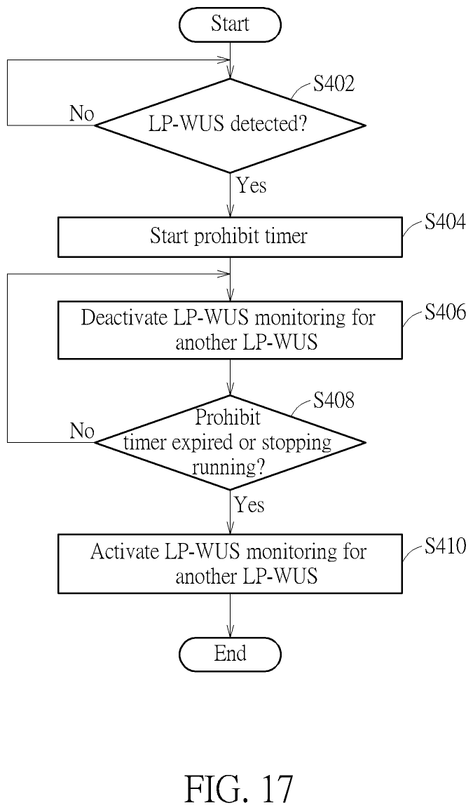

Please refer to FIG. 17 in conjunction with FIG. 14. FIG. 17 is a flowchart illustrating operations performed by the communication apparatus (e.g., UE) 110 for activation/deactivation of LP-WUS monitoring according to an embodiment of the present invention. The processor 112 may include a prohibit timer 113. In FIG. 14, the prohibit timer 113 is illustrated as an internal component of the processor 112. However, this is for illustrative purposes only, and is not meant to be a limitation of the present invention. In an alternative design, the prohibit timer 113 may be implemented by a separate hardware timer. At step S402, the processor 112 checks if an LP-WUS is detected via the LP-WUR 118. When LP-WUS is detected, the processor 112 starts the prohibit timer 113 (step S404), and deactivates LP-WUS monitoring for another LP-WUS (step S406). At step S408, the processor 112 checks if the prohibit timer 113 is expired or stops running. During a period in which the prohibit timer 113 is running, the processor 112 deactivates LP-WUS monitoring for another LP-WUS (steps S408 and S406). However, when the prohibit timer 113 is expired or stops running, the processor 113 activates the LP-WUS monitoring for another LP-WUS (step S410).

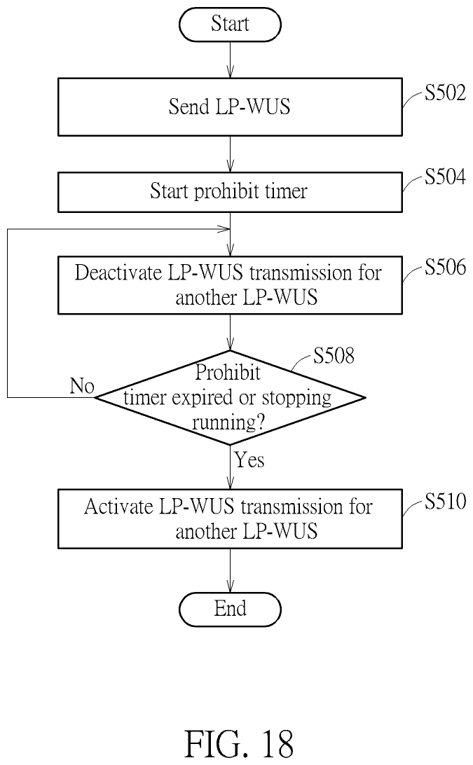

Please refer to FIG. 18 in conjunction with FIG. 14. FIG. 18 is a flowchart illustrating operations performed by the network apparatus (e.g., gNB) 120 for activation/deactivation of LP-WUS transmission according to an embodiment of the present invention. The processor 122 may include a prohibit timer 123. In FIG. 14, the prohibit timer 123 is illustrated as an internal component of the processor 122. However, this is for illustrative purposes only, and is not meant to be a limitation of the present invention. In an alternative design, the prohibit timer 123 may be implemented by a separate hardware timer. At step S502, the processor 122 sends an LP-WUS via the transceiver 126 (particularly, transmitter of transceiver 126). When LP-WUS is sent by the network apparatus 120, the processor 122 starts the prohibit timer 123 (step S504), and deactivates LP-WUS transmission for another LP-WUS (step S506). At step S508, the processor 122 checks if the prohibit timer 123 is expired or stops running. During a period in which the prohibit timer 123 is running, the processor 122 deactivates LP-WUS transmission for another LP-WUS (steps S508 and S506). However, when the prohibit timer 123 is expired or stops running, the processor 122 activates the LP-WUS transmission for another LP-WUS (step S510).

In summary, LP-WUR should not expect to receive another LPWUS after a certain time. To reduce the chance of false alarms, a prohibit timer is a timer that prohibits gNB from sending LPWUS continuously. The prohibit timer is maintained by UE and gNB. If the prohibit timer runs, UE does not expect to receive another LPWUS sent by the gNB. If the prohibit timer expires or stop running, UE starts to monitor LPWUS until another LPWUS detected.

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication apparatus comprising:
a low power wakeup receiver (LP-WUR); and
a processor, configured to receive signals from a network apparatus via the LP-WUR, and perform operations comprising:
receiving at least one synchronization signal sent by the network apparatus, wherein the at least one synchronization signal comprises at least one of a primary synchronization signal (PSS) and a secondary synchronization signal (SSS); and
using the at least one synchronization signal to detect timing of a low power wakeup signal (LP-WUS).

2. The communication apparatus of claim 1, wherein the at least one synchronization signal is compliant with a 5G New Radio (NR) standard.

3. The communication apparatus of claim 1, wherein using the at least one synchronization signal to detect the timing of the LP-WUS comprises:
performing cell identification according to the at least one synchronization signal; and
in response to the cell identification indicating that the at least one synchronization signal is provided from a serving cell of the communication apparatus, using a timing offset between the at least one synchronization signal and the LP-WUS to synchronize the timing of the LP-WUS.

4. The communication apparatus of claim 1, wherein the operations performed by the processor further comprise:
receiving a parameter indicative of the timing offset from the network apparatus.

5. The communication apparatus of claim 1, wherein the operations performed by the processor further comprise:
in response to detecting the LP-WUS, starting a prohibit timer; and
during a period in which the prohibit timer is running, deactivating LP-WUS monitoring for another LP-WUS.

6. The communication apparatus of claim 5, wherein the operations performed by the processor further comprise:
in response to the prohibit timer being expired or stopping running, activating the LP-WUS monitoring for another LP-WUS.

7. The communication apparatus of claim 1, wherein the operations performed by the processor further comprise:
activating or deactivating LP-WUS monitoring based on preconfigured criteria or signaling.

8. A communication method comprising:
receiving at least one synchronization signal via a low power wakeup receiver (LP-WUR), wherein the at least one synchronization signal comprises at least one of a primary synchronization signal (PSS) and a secondary synchronization signal (SSS) sent by a network apparatus; and
using the at least one synchronization signal to detect timing of a low power wakeup signal (LP-WUS).

9. The communication method of claim 8, wherein the at least one synchronization signal is compliant with a 5G New Radio (NR) standard.

10. The communication method of claim 8, wherein using the at least one synchronization signal to detect the timing of the LP-WUS comprises:
performing cell identification according to the at least one synchronization signal; and
in response to the cell identification indicating that the at least one synchronization signal is provided from a serving cell, using a timing offset between the at least one synchronization signal and the LP-WUS to synchronize the timing of the LP-WUS.

11. The communication method of claim 8, further comprising:
receiving a parameter indicative of the timing offset from the network apparatus.

12. The communication method of claim 8, further comprising:
in response to detecting the LP-WUS, starting a prohibit timer; and
during a period in which the prohibit timer is running, deactivating LP-WUS monitoring for another LP-WUS.

13. The communication method of claim 12, further comprising:
in response to the prohibit timer being expired or stopping running, activating the LP-WUS monitoring for another LP-WUS.

14. A network apparatus comprising:
a transmitter; and
a processor, configured to send signals to a communication apparatus via the transmitter, and perform operations comprising:
sending at least one synchronization signal to the communication apparatus, wherein the at least one synchronization signal comprises at least one of a primary synchronization signal (PSS) and a secondary synchronization signal (SSS); and
sending a low power wakeup signal (LP-WUS) to the communication apparatus according to a timing offset between the at least one synchronization signal and the LP-WUS.

15. The network apparatus of claim 14, wherein the at least one synchronization signal is compliant with a 5G New Radio (NR) standard.

16. The network apparatus of claim 14, wherein the operations performed by the processor further comprise:
configuring the timing offset; and
sending a parameter indicative of the timing offset to the communication apparatus.

17. The network apparatus of claim 14, wherein the operations performed by the processor further comprise:
in response to sending the LP-WUS, starting a prohibit timer; and
during a period in which the prohibit timer is running, deactivating LP-WUS transmission for another LP-WUS.

18. The network apparatus of claim 17, wherein the operations performed by the processor further comprise:
in response to the prohibit timer being expired or stopping running, activating the LP-WUS transmission for another LP-WUS.

19. The network apparatus of claim 14, wherein activation or deactivation of LP-WUS monitoring is based on preconfigured criteria or signaling.
